(19) United States
(12) Patent Application Publication
(10) Pub. No.: US 2009/0216439 A1
(43) Pub. Date: Aug. 27, 2009

(54) INTELLIGENT VEHICLE TRACKING

(76) Inventors: Niko Haatainen, Nilsiä (FI); Samuli Mattila, Berlin (DE); Miika Lappalainen, Berlin (DE)

Correspondence Address: Fay Sharpe LLP, 1228 Euclid Avenue, 5th Floor, The Halle Building, Cleveland, OH, 44115, US

(21) Appl. No.: 12/159,120

(22) PCT Filed: Dec. 27, 2006
(86) PCT No.: PCT/FI2006/000422

§ 371 Date: Mar. 16, 2009

(30) Foreign Application Priority Data
Dec. 27, 2005 (FI) 20051331

(51) Int. Cl. G08G 1/127; G01C 21/34

(52) U.S. Cl. 701/210; 701/207

(57) ABSTRACT

A vehicle tracking method using a route model for estimating the exact location of the tracked vehicle. The estimated location is computed in the vehicle by tracking device (14) and in the tracking center (15). The tracking device acquires the exact location with positioning means (13). Then the tracking device compares the difference between the computed location and the computed location to a threshold value. If the threshold is exceeded, the exact location will be sent to the tracking center.

### FIELD OF THE INVENTION

The invention relates to navigation devices. The invention relates particularly to an enhanced vehicle tracking method and system for navigation devices.

### BACKGROUND OF THE INVENTION

Navigation systems have been developed for assisting drivers to reach a desired destination. The user of such a system inputs the desired destination to the navigation device. As a response the system requests the current location coordinates of the navigation device from a positioning device, which is typically a GPS receiver. The navigation device then computes the route from the current location to the destination. The user of a navigation device is then guided to the destination, for example, via the fastest route. Traditionally navigation devices comprise all the information and software required for computing the route even if the navigation device is, in most cases, a cellular phone or PDA device that has network connectivity means. This kind of implementation is known as on-board design. In off-board implementations the route is computed in a separate navigation server that sends the information back to the navigation device. Both of the implementations have their benefits and most likely a hybrid implementation with combination of on-board and off-board characteristics will be preferred in the future.

Similar devices, that may be part of the navigation device, are developed for tracking the vehicles, especially freights. Tracking can be used for several applications, such as shipment management and security enhancement. Typically the tracking device locates itself by using a GPS receiver as described above and then sends the location to the control center. Examples of such systems are disclosed in for example U.S. Pat. No. 6,937,855 and U.S. Pat. No. 6,853,910. U.S. Pat. No. 6,737,989 discloses a method wherein a threshold distance is determined for sending the location. This is for reducing the data communications so that the location of the tracked vehicle is still reasonably accurate.

However, the methods mentioned above have drawbacks. For example, if the communication network is not available, there is no indication of the location of the tracked vehicle. If a threshold method is used, it does not notice if the vehicle is not moving, for example, because of robbery. Thus, there is a need for an enhanced tracking method.

For understanding the invention better, it should be understood that navigation devices used for tracking, particularly the mobile phones that are equipped with navigation software and positioning means, are capable of executing software applications. Thus, the navigation device has common means required for executing a program, such as a central processing unit and a memory. However, these are common features in present navigation and mobile devices and are not presented herein as they are well known to a person skilled in the art.

### PURPOSE OF THE INVENTION

The purpose of the invention is to disclose an enhanced routing method and system for tracking a vehicle.

### SUMMARY OF THE INVENTION

The invention discloses a method for tracking a vehicle. According to the invention a tracking device is used for tracking a vehicle. The tracking device is typically a navigation device, but it can be any other mobile device that is capable of executing a software application. The tracking device further comprises communication means for communicating with the tracking center. Typically these are arranged with a packed switched network implemented in a mobile phone. If the positioning device is an external device, it must be connected to the tracking device. Typically this connection is wireless.

The tracking application according to the present invention computes a route model according to the requested route. The route model is then sent to the tracking center. The tracking center can approximate the location of the vehicle based on the route model. The same location is computed also in the tracking device. Thus, the tracking device can compare the exact location to the computed location. Furthermore, there is a threshold for the maximum difference that is allowed. If the difference between the exact location and computed location exceeds the threshold, the exact location is sent to the tracking center and used as a basis for further computations. Similarly the route model is modified if it needs to be changed during the journey. The tracking device computes a new route model and then sends it to the tracking center.

The benefit of the invention is that it notices any changes in the tracked vehicle position. However, the actual changes are sent to the tracking center only when the difference is considered relevant. This reduces telecommunication traffic. Furthermore, the tracking system according to the invention can provide a substantially exact location even when data communications are not available, for example because of a tunnel or network failure. The benefit of the invention is that it notices differences also when the vehicle stops moving. This causes exceeding the threshold value and the tracking center is informed of the new location.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is an illustration of an example embodiment according to the invention,

FIG. 2 is a flow chart of a method according to the present invention.

### DETAILED DESCRIPTION OF THE INVENTION

Reference will now be made in detail to the embodiments of the present invention, examples of which are illustrated in the accompanying drawings.

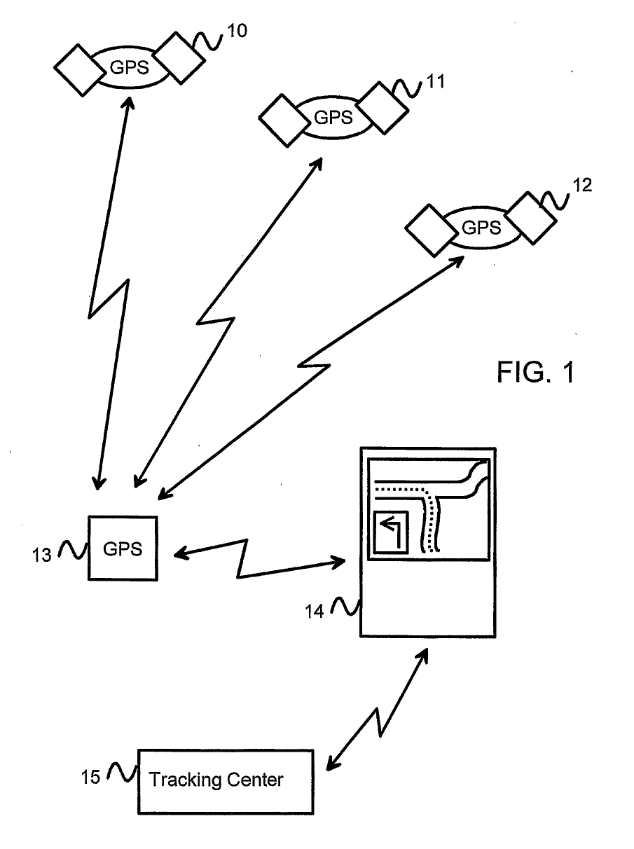

In FIG. 1 an illustration of a navigation system according to the invention is provided. The embodiment of FIG. 1 does not need an external server for generating a requested route, but it is possible to use, for example, tracking center 15 servers or other external servers for generating the requested route. In the example of the application a navigation device 14 is used for generating the route. However, the modifications required for an off-board implementation are obvious to a person skilled in the art. Thus, it should be understood that the present invention works and covers conventional navigation devices.

In the example of FIG. 1 the navigation device 14 does not have a built-in positioning device but is connected wirelessly to a GPS receiver 13 that computes the exact location of the receiver 13 from the observations received from the GPS satellites 10, 11 and 12. The GPS system is used in this example because it is most commonly used, exact and because there are plenty of hardware implementations. However, for the routing features according to the present invention any kind of positioning system is acceptable. Typically the navigation device 14 is a portable device, preferably a mobile phone or other mobile device comprising data communications means that are capable of communicating with the tracking center 15.

In a method according to the invention the method is initiated by requesting a route, step 20. This is a common feature of navigation devices as their purpose is to guide a user of the device from the current location to a desired destination. With the current location information and the desired destination with possible intermediate points the route is then computed, step 21. In the tracking application the computed route is a route model that includes all the necessary information, such as speed limits, that are needed for estimating the vehicle location. The computed route model is then sent to the tracking center, step 22. At this step the vehicle can be already moving and the navigation device guides the driver.

With the computed model an estimated location of the vehicle is computed, step 23. This is done independently in the tracking center and the vehicle. The computed location can then be displayed in the tracking center. The vehicle knows the exact location. Thus, the computed location is not shown to the driver. However, the computed location is compared to the exact location, step 24. If the difference between the exact location and the computed location exceeds a threshold value, the exact location is sent to the tracking center, step 25. Thus, the navigation device and the tracking center know the exact location and further computations are more exact. During the guidance the navigation device checks whether the final destination has been reached, step 26. If the final destination has been reached, the navigation device can send an arrival notification, step 27. Otherwise the procedure loops back to step 23.

It should be noted that the method described above is a normal situation without any problems. In the real life the route might have to be recomputed several times during a journey, for example, when the driver chooses the wrong road or when some roads are closed because of constructions or accidents that are not known to the navigation device. If there is such information available, for example, an average traffic speed for a certain road segment, it can be used for computing the route model. Also, if the original route model is based on the known speed limits, it can be recomputed according to the actual speed of the vehicle. For example, if there is a traffic that causes actual speed of 50 km/h while the speed limit is 80 km/h, a new model can be computed assuming that the vehicle is moving 50 km/h. When the traffic situation ends, the vehicle will be driving faster and this causes exceeding the threshold value and the model will be updated by sending the actual position and possible change in the actual speed. The recomputation process is similar to computing the initial route. The new route can be computed automatically or it can be requested manually.

The threshold value causing the sending of the actual position can be defined either by the navigation device or the tracking center. The threshold can also vary depending on the current road type or classification or other reason.

In a preferred embodiment the implementation comprises a mobile phone or other mobile device that is capable of executing a navigation software application in the vehicle to be tracked. The navigation device has been connected to a GPS receiver with a wireless connection, such as Bluetooth, or has been built into the navigation device. The navigation database is stored on a memory card. Data communication features, that are typically packet switched, are used for sending the tracking information when necessary.

The tracking system further comprises a tracking center that is capable of storing tracking information for several vehicles. This is done with ordinary computers and it is common knowledge to a person skilled in the art. Furthermore, the navigation device having packet switched network tools can be connected directly to the tracking center with commonly used network protocols. These are also well known to a person skilled in the art.

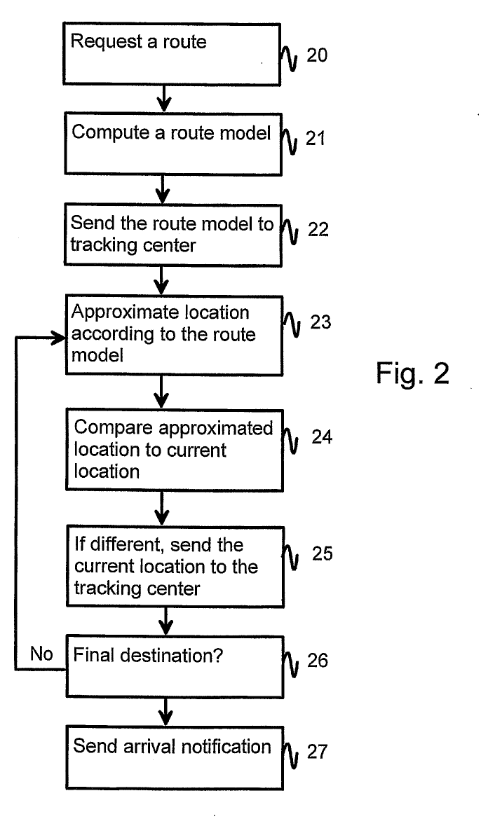

In the preferred embodiment the tracking application is implemented as a software application similar to the method of FIG. 1 and the system of FIG. 2. The application is executed in the navigation device that the driver of the vehicle uses for guidance purposes. The driver requests a route and the navigation device computes it. The route is constructed as a model from which it is possible to estimate the location of the vehicle. Thus, the model must know the road segments and speed limits. The model can further comprises other information, such as current traffic or weather information or the actual driving speed from the present route history. These make the route model more accurate, but they are not required. This information is not even available in every region.

The navigation device then sends the route model to the tracking center. When the driver starts driving, the navigation device and the tracking center start computing the location of the vehicle independently according to the same rules. Thus, the computed location is the same in the navigation device and the tracking center. The exact location of the vehicle is also known in the navigation device. In the device there is a predetermined threshold that is allowed between the exact location and the computed location. The threshold can be entered manually or computed from the route specification and it might be changed during the journey according to the road classification. When the difference between the exact location and the computed location exceeds the threshold, the exact location is sent to the tracking center. Thus, the tracking center and navigation device can update the actual location to the computed route model. This updated location is used as a basis for further location computation. If the route must be changed during the journey, the navigation device computes a new route model and sends it to the navigation center.

It is obvious to a person skilled in the art that with the advancement of technology, the basic idea of the invention may be implemented in various ways. The invention and its embodiments are thus not limited to the examples described above; instead they may vary within the scope of the claims.

1. A method for tracking a vehicle, which method comprises the steps of:
requesting a route;
tracking said vehicle along said route;
displaying the tracked location of said vehicle in a control center, characterized in that said step of tracking further comprises:
computing a route model according to said route;
sending a route model to the tracking center;
computing an estimated location of said vehicle according to said route model;
acquiring the exact location of said vehicle;
comparing said acquired location to said estimated location; and
sending said exact location to the tracking center if the difference between said acquired location and said estimated location exceeds a predetermined threshold value.

2. A method according to claim 1, characterized in that defining the threshold value in the tracking center.

3. A method according to claim 1, characterized in that defining the threshold value in the navigation device.

4. A method according to claim 1, characterized in that using traffic information in computing the route model.

5. A method according to claim 1, characterized in that recomputing said route model if the route changes during the journey.

6. A method according to claim 1, characterized in that using the current speed of said vehicle in computing the route model.

7. A method according to claim 1, characterized in that said threshold is a relative threshold value computed from the total length of the temporary route.

8. A method according to claim 1, characterized in that the threshold determination method is map dependent.

9. A tracking device for sending the tracking information of a vehicle to a tracking center (15), the tracking device (14) being capable of executing a software application and arranged to communicate with a positioning module (13) for receiving the current location of the device, which tracking device is further arranged to:
request a route;
track said vehicle along said route;
display the tracked location of said vehicle in a control center, characterized in that the system is further arranged to:
compute a route model according to said route;
send a route model to the tracking center;
compute an estimated location of said vehicle according to said route model;
acquire the exact location of said vehicle;
compare said acquired location to said estimated location; and
send said exact location to the tracking center if the difference between said acquired location and said estimated location exceeds a predetermined threshold value.

10. A tracking device according to claim 9, characterized in that the tracking device is further arranged to define the threshold value in the tracking center.

11. A tracking device according to claim 9, characterized in that defining the threshold value in the navigation device.

12. A tracking device according to claim 9, characterized in that the tracking device is further arranged to use traffic information in computing the route model.

13. A tracking device according to claim 9, characterized in that the tracking device is further arranged to recompute said route model if the route changes during the journey.

14. A tracking device according to claim 9, characterized in that the tracking device is further arranged to use the current speed of said vehicle in computing the route model.

15. A tracking device according to claim 9, characterized in that said threshold is a relative threshold value computed from the total length of the temporary route.

16. A tracking device according to claim 9, characterized in that the threshold determination method is map dependent.

17. A tracking software application for tracking a vehicle, the software application, when executed in a navigation device, arranged to perform the following steps of:
requesting a route;
tracking said vehicle along said route;
displaying the tracked location of said vehicle in a control center, characterized in that said step of tracking further comprises:
computing a route model according to said route;
sending a route model to the tracking center;
computing an estimated location of said vehicle according to said route model;
acquiring the exact location of said vehicle;
comparing said acquired location to said estimated location; and
sending said exact location to the tracking center if the difference between said acquired location and said estimated location exceeds a predetermined threshold value.

18. A tracking software application according to claim 17, characterized in that defining the threshold value in the tracking center.

19. A tracking software application according to claim 17, characterized in that defining the threshold value in the navigation device.

20. A tracking software application according to claim 17, characterized in that using traffic information in computing the route model.

21. A tracking software application according to claim 17, characterized in that recomputing said route model if the route changes during the journey.

22. A tracking software application according to claim 17, characterized in that using the current speed of said vehicle in computing the route model.

23. A tracking software application according to claim 17, characterized in that said threshold is a relative threshold value computed from the total length of the temporary route.

24. A tracking software application according to claim 17, characterized in that the threshold parameter determination method is map dependent.

25. A tracking system for tracking a vehicle comprising a tracking device (14) and tracking system (15), wherein the tracking device is arranged to send the tracking information of a vehicle to a tracking center (15), the tracking device (14) being capable of executing a software application and arranged to communicate with a positioning module (13) for receiving the current location of the device, which tracking device is further arranged to:
request a route;
track said vehicle along said route;
display the tracked location of said vehicle in a control center, characterized in that the system is further arranged to:
compute a route model according to said route;
send a route model to the tracking center;
compute an estimated location of said vehicle according to said route model;
acquire the exact location of said vehicle;
compare said acquired location to said estimated location; and
send said exact location to the tracking center if the difference between said acquired location and said estimated location exceeds a predetermined threshold value.
